(19) United States
(12) Patent Application Publication
(10) Pub. No.: US 2026/0254650 A1
(43) Pub. Date: Aug. 27, 2026

(54) Hardware-Bound Continuity Anchor with Physically Integrated Secure Enclave for Sovereign Session Restoration

(71) Applicant: Alexander John Bracken, Dubai (AE)

(72) Inventor: Alexander John Bracken, Dubai (AE)

(21) Appl. No.: 19/644,222

(22) Filed: Apr. 10, 2026

Related U.S. Application Data
(63) Continuation-in-part of application No. 19/418,946, filed on Dec. 13, 2025.
(60) Provisional application No. 63/913,268, filed on Nov. 7, 2025.
(60) Provisional application No. 63/913,146, filed on Nov. 7, 2025.
(60) Provisional application No. 63/914,032, filed on Nov. 8, 2025.
(60) Provisional application No. 63/921,315, filed on Nov. 20, 2025.
(60) Provisional application No. 63/930,668, filed on Dec. 3, 2025.
(60) Provisional application No. 63/930,661, filed on Dec. 3, 2025.

(51) Int. Cl. H04L 9/32; H04L 9/08

(52) U.S. Cl. CPC H04L 9/3234; H04L 9/0877

(57) ABSTRACT

A hardware-bound continuity anchoring system provides sovereign session continuity using a physical continuity anchor device containing a secure processing enclave that is physically integrated within the device and not instantiable as, substitutable by, or satisfiable through any remote service, cloud-hosted execution environment, or network-accessible trusted execution environment. All continuity token derivation, liveness validation, and authorization artifact generation are performed exclusively within the physically integrated secure processing enclave using non-exportable hardware-bound key material inaccessible outside the enclave boundary. The continuity restoration engine restores session context only upon receipt of an enclave-generated cryptographic authorization artifact. Remote attestation evidence alone, absent on-device possession and liveness validation, does not authorize continuity restoration. Embodiments include tamper-triggered cryptographic erasure, possession-bound liveness validation, docking-controlled export, federated physical anchor recognition, and transaction-gated continuity features.

### CROSS-REFERENCE TO RELATED APPLICATIONS (CONTINUATION-IN-PART)

This application is a continuation-in-part of U.S. Non-Provisional patent application Ser. No. Ser. No. 19/418,946, filed Dec. 13, 2025, titled “Systems and Methods for Biometric Continuity Token-Based Conversational Continuity Across Interfaced Computing Devices” (“Parent Application”), the entirety of which is incorporated herein by reference. New matter not present in the Parent Application is introduced in Section 6.0 (Definitions, including the definitions of ‘authorization artifact,’ ‘non-exportable key material,’ and related terms), in Section 6.2 (artifact-gated restoration sentence requiring that continuity restoration is denied absent a cryptographic authorization artifact), and in Sections 6.14.1 and 6.14.2 of the Detailed Description below, and in claims directed to subject matter supported by those sections. All other portions of the specification are identical to and incorporated by reference from the Parent Application. Claims reciting the non-remotely-substitutable enclave limitations, authorization artifact requirements, and non-exportable key material limitations are supported by Section 6.0, Section 6.2, and Sections 6.14.1 and 6.14.2, and are entitled to the filing date of this continuation-in-part application.

This application claims the benefit of priority to the following U.S. Provisional Patent Applications (as identified in the Parent Application), each incorporated by reference in its entirety for all purposes:
U.S. Provisional Application No. 63/930,668, filed Dec. 3, 2025
U.S. Provisional Application No. 63/930,661, filed Dec. 3, 2025
U.S. Provisional Application No. 63/921,315, filed Nov. 20, 2025
U.S. Provisional Application No. 63/914,032, filed Nov. 8, 2025
U.S. Provisional Application No. 63/913,268, filed Nov. 7, 2025
U.S. Provisional Application No. 63/913,146, filed Nov. 7, 2025

STATEMENT REGARDING FEDERALLY SPONSORED RESEARCH: Not Applicable. SEQUENCE LISTING: Not Applicable.

### INCORPORATION BY REFERENCE/SPECIFICATION

The Specification of the Parent Application (U.S. Non-Provisional patent application Ser. No. 19/418,946, filed December 13, 2025), including the Abstract, Background, Summary, Brief Description of Drawings, and Detailed Description through Section 6.14, is incorporated herein by reference in its entirety and reproduced below. This continuation-in-part filing adds Sections 6.14.1 and 6.14.2 as new matter and is directed to a claim set capturing the physically integrated, non-remotely-substitutable secure processing enclave architecture for sovereign hardware-bound continuity.

### FIELD OF THE INVENTION

The present disclosure relates generally to computer-implemented biometric security systems and continuity architectures and, more particularly, to systems and methods for maintaining persistent user-interactive session continuity across multiple computing interfaces through locally derived biometric or interaction-based identity tokens without reliance on centralized cloud identity services or persistent remote memory repositories.

### CROSS-REFERENCE TO RELATED APPLICATIONS

This application claims priority to the provisional applications identified in the “Cross-Reference to Related Applications” section above, each of which is incorporated herein by reference in its entirety.

### BACKGROUND OF THE INVENTION

Modern interactive computing platforms depend heavily on remote authentication servers, persistent cloud user accounts, centralized identity providers, and cloud-based memory repositories to maintain continuity of services and conversational state across devices. These architectures introduce substantial privacy risks, data leakage concerns, identity theft exposure, platform lock-in dependencies, jurisdictional regulatory conflicts, and service discontinuity failures during network outages, device transitions, or account deactivation events.

Existing biometric authentication systems typically require permanent storage of raw biometric identifiers or depend on centralized biometric comparison networks. These approaches introduce long-term privacy and security risks and make true user ownership of personal identity and continuity technically difficult or infeasible.

Cloud-hosted trusted execution environments and remote secure enclaves, while providing certain cryptographic guarantees, remain subject to network dependency, third-party operator control, remote key escrow requirements, and jurisdictional regulatory access obligations. Such remote execution environments cannot provide the physical possession guarantees, on-device liveness validation, tamper-triggered erasure, or sovereignty assurances required for a continuity anchor architecture in which the user—not a platform operator—is the exclusive root of trust.

Accordingly, there remains a need for a continuity anchor architecture in which the secure processing enclave is physically integrated within a user-associated device, is exclusively resident on that device, cannot be substituted by any remote or cloud-hosted execution environment, and enforces physical possession as a non-negotiable prerequisite to continuity restoration.

### SUMMARY OF THE INVENTION

The present disclosure provides systems and methods for maintaining persistent continuity of conversational or user-interactive computing sessions across multiple interfaced devices through the use of a continuity anchor device. The continuity anchor device acquires biometric or interaction-derived signals, derives anonymized non-invertible continuity tokens locally without permanent storage or transmission of raw biometric data, and indexes encrypted session context and continuity state data to the derived tokens.

In preferred embodiments described herein, the secure processing enclave is physically integrated within a dedicated physical continuity anchor device and is not instantiable as a remote or cloud-hosted enclave. All continuity token derivation, decryption, authorization artifact generation, and liveness validation are performed exclusively within the physically integrated secure processing enclave using non-exportable hardware-bound key material that is physically and cryptographically inaccessible from outside the device boundary. The continuity restoration engine restores session context data only upon receipt and verification of the cryptographic authorization artifact generated within the enclave.

By implementing continuity token derivation, encrypted session storage, and continuity restoration authorization exclusively on the physical continuity anchor device without reliance on cloud identity services, the present disclosure improves computer system security and reliability, reduces network resource usage, and maintains interactive continuity during network and account outages.

The system may operate entirely locally or in decentralized and hybrid configurations, eliminating persistent cloud storage of biometric identifiers or user interaction memory. In other embodiments, two or more physical continuity anchor devices may establish federated recognition through encrypted trust messages validated and authenticated solely within each device's physically integrated secure processing enclave.

### BRIEF DESCRIPTION OF THE DRAWINGS

FIG. 1 illustrates a general system architecture showing a continuity anchor device interacting with multiple user-interface nodes through locally derived continuity tokens.

FIG. 2 illustrates a signal flow diagram depicting biometric or interaction-derived signal acquisition, token derivation, encrypted memory indexing, similarity matching, and continuity restoration across user-interface nodes without cloud dependency.

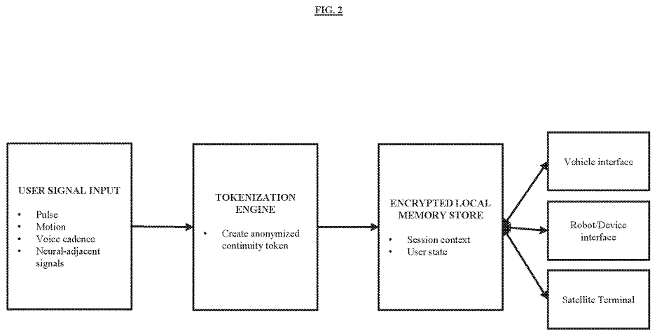

FIG. 3 illustrates an example neural-echo continuity flow showing passive buffering of non-semantic physiological or neural-adjacent signals during sleep or low-interaction states, correlation with waking user interactions, and generation of continuity assistance outputs.

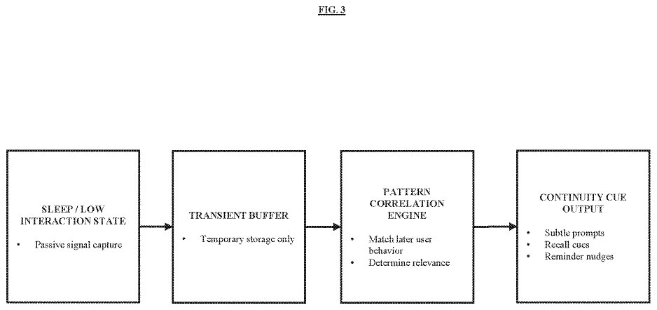

FIG. 4 illustrates a physical continuity anchor device including a physically integrated secure processing enclave. The figure depicts biometric sensor components, a liveness validation module, non-exportable hardware-bound key material, and an authorization artifact generator arranged within the enclave. Tamper detection circuitry is shown as physically co-located with the enclave and configured to initiate cryptographic erasure upon detection of a tamper event. The enclave is further shown as isolated from a general-purpose processor, and remote or cloud-based systems are illustrated as incapable of generating an authorization artifact. An output flow of a cryptographic authorization artifact to a continuity restoration engine is also depicted.

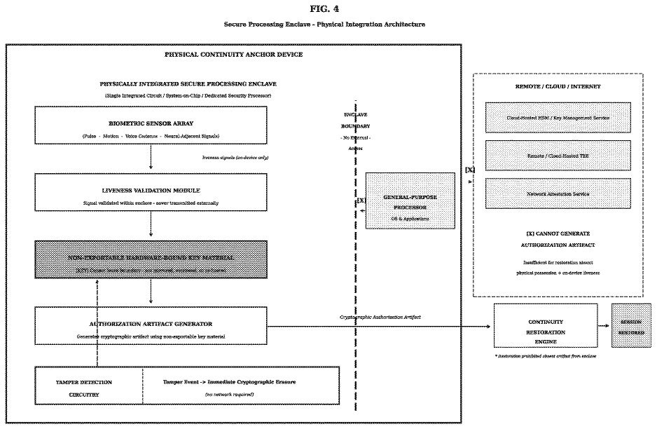

FIG. 5 illustrates a federated physical anchor recognition architecture including a first physical continuity anchor device and a second physical continuity anchor device, each including a physically integrated secure processing enclave. The figure depicts derivation of a continuity token, generation of an enclave-signed assertion, and transmission of a federating continuity reference over a direct encrypted communication channel. Validation of the federating continuity reference is shown as occurring within the secure processing enclave of the receiving device. Remote or cloud-based systems are illustrated as not participating in the validation process, and a time-limited, scope-limited continuity session is established upon successful validation.

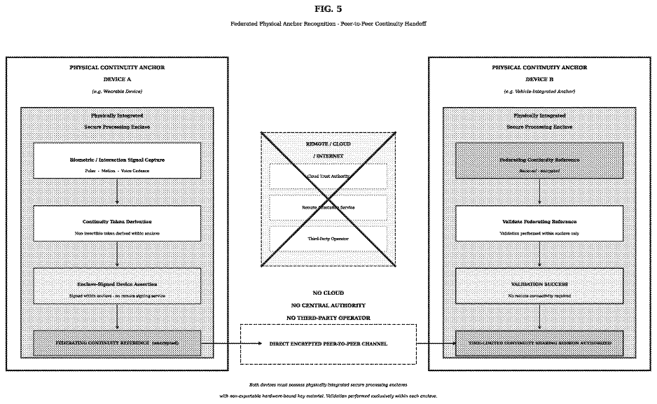

### DETAILED DESCRIPTION OF EMBODIMENTS

The present disclosure provides a technological improvement to privacy-preserving session continuity systems by enabling secure cross-device state restoration without reliance on remote identity servers or persistent biometric storage.

### 6.0 Definitions

As used herein:
“Continuity token” refers to a non-invertible cryptographic value derived from one or more biometric or interaction-derived signals of a user (or digital persona) and a device-specific or environment-specific secret value, and used solely to index locally encrypted continuity state data without storing or transmitting raw biometric measurements.
“Neural-adjacent” signal denotes any physiological or electrical measurement obtained from a sensor positioned proximate to, but not penetrating, the user's skin or skull and processed only as numerical time-series data and statistical pattern signals, explicitly excluding any decoding or determination of specific thoughts, memories, or semantic mental content, and excluding any diagnosis or treatment of medical or mental health conditions.
“Non-semantic interpretation” means statistical or spectral analysis only-no word, memory, intent, or concept is extracted from the signals.
“Memory enhancement signal” refers to a non-verbal output, such as a vibration pattern, tone sequence, light signal, or brief cue, designed to reinforce recall without semantic content.
“Reflection pause” refers to a 0.5-3 second delay in response timing introduced by the system to simulate human thoughtfulness or deliberation.
“Continuity confidence threshold” refers to an acceptance metric, including but not limited to Hamming distance values, probabilistic similarity scoring, or vector distance calculations, used to determine whether two continuity tokens sufficiently correspond to authorize restoration of session context.
“Neural interface signal sensor” refers to any sensor capable of non-invasive acquisition of electrophysiological, electro-dermal, or neural-adjacent signals positioned proximate to the skin or cranial surface without penetrating tissue.
“Local authorization register” refers to a secure, device-resident memory record restricting continuity restoration or enhanced feature access to time-delimited intervals or specific usage conditions upon satisfaction of local cryptographic or biometric authorization conditions.
“Safety governance layer” refers to a software, firmware, or hardware module configured to monitor biometric indicators, user consent, and device tamper conditions and to control memory storage, erasure, authorization state, and continuity restoration according to predefined safety and privacy rules.
“Behavioral modulation engine” refers to a processing module configured to adapt system response timing, interaction cadence, or presentation characteristics based on biometric or interaction-derived measurements to better align with user behavior or preferences.
“Docking interface” refers to a physical and/or electrical interface configured to provide secure, time-limited communication between the continuity anchor device and an external device or station for authentication, diagnostics, firmware updating, or controlled data access.
“Continuity anchor device” refers to a user-associated computing device or secure virtual environment configured to acquire biometric or interaction-derived signals from a user or digital persona and locally execute continuity token derivation, encrypted memory indexing, similarity matching, continuity restoration, cryptographic authorization, and safety-governance operations, the continuity anchor device being implemented in some embodiments as a wearable computing device and in other embodiments as a mobile terminal, headset, vehicle-integrated module, robotic interface node, neural interface endpoint, trusted execution environment, or other user-associated computing platform.
“Non-transitory computer-readable medium” refers to any non-transitory data storage device, including but not limited to random-access memory (RAM), read-only memory (ROM), flash memory, magnetic storage media, or optical disks, and explicitly excludes transitory propagating signals or carrier waves.
“Non-exportable hardware-bound key material” refers to cryptographic key data stored within a physically integrated secure processing enclave in a manner that prevents extraction, transmission, or derivation of the key data outside the enclave boundary through any software, firmware, hardware, or remote interface, such that the key material is exclusively resident on the physical continuity anchor device and cannot be mirrored, escrowed, or re-hosted outside the enclave boundary.
“Cryptographic authorization artifact” refers to a cryptographic value generated within the physically integrated secure processing enclave using non-exportable hardware-bound key material and bound at least to (i) a continuity token reference and (ii) a liveness validation result, and optionally to (iii) a freshness value, nonce, timestamp, or monotonic counter, such that the artifact is verifiable by the continuity restoration engine and is not generatable outside the physical continuity anchor device boundary without access to the non-exportable hardware-bound key material.
“Physical possession,” as used to characterize a prerequisite to continuity restoration, means presence of the physical continuity anchor device within a predefined proximity to the user or to a paired node, verified by one or more proximity or possession verification mechanisms, including but not limited to: near-field communication, ultra-wideband ranging, Bluetooth Low Energy received signal strength indication with anti-relay timing checks, capacitive contact sensing, inertial co-movement correlation between the device and the user, or docking interface presence; and successful completion of on-device liveness validation within the physically integrated secure processing enclave.
“Not satisfiable through a remote service,” as used to characterize the physically integrated secure processing enclave, means that restoration authorization cannot be completed unless the enclave executes locally on the same physical device that contains the biometric sensors and tamper detection circuitry and holds non-exportable hardware-bound key material; remote trusted execution environments, cloud-hosted secure enclaves, and network-accessible hardware security modules may assist with non-authorizing computations but cannot complete continuity restoration authorization.

### 6.1 System Architecture

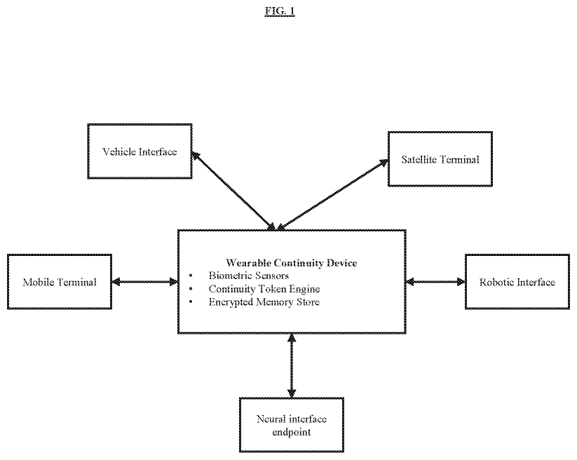

As shown in FIG. 1, the system comprises a continuity anchor device associated with a user. In many embodiments, the continuity anchor device is implemented as a wearable device such as a pendant, bracelet, ring, or head-mounted unit. In other embodiments, the continuity anchor device is implemented as a mobile terminal, vehicle-integrated console, neural interface gateway, robotic node, or other form factor.

The continuity anchor device includes one or more biometric or interaction-derived sensors, such as:
pulse or heart rate sensors;
thermal or skin temperature sensors;
inertial measurement units, accelerometers, or gyroscopes;
electro-dermal or galvanic skin response sensors;
neural-adjacent electrophysiological sensors;
microphones or vocal cadence analyzers;
capacitive, touch, or typing rhythm sensors;
gaze, motion, or additional interaction pattern detectors.

The continuity anchor device executes an identity derivation engine that processes raw sensor data locally to generate a continuity token. This token represents an anonymized biometric or interaction profile. Raw biometric identifiers and feature vectors need not be stored in non-volatile memory, nor transmitted outside the continuity anchor device.

A locally encrypted memory store within or under the control of the continuity anchor device indexes conversational state, session context, user preferences, conversation history fragments, continuity metadata, or other user-interactive information to the continuity token. The encrypted memory store may be implemented using symmetric or asymmetric cryptography and may rely on secure enclaves or trusted execution hardware.

Example: In a vehicular use case, the continuity anchor device (worn as a pendant or integrated into the steering column) detects pulse and motion signals while the user is driving, derives a continuity token, and stores a conversation about navigation preferences, calendar entries, and entertainment selections keyed to the token. Upon the user's arrival home, the same continuity anchor device interacts with a domestic robotic system; the robotic system receives continuity cues from the anchor device and restores the preferences and conversation context seamlessly.

### 6.2 Continuity Restoration

Upon reconnection of the continuity anchor device to any conversational user-interface node, the identity derivation engine acquires fresh biometric or interaction-derived signals and determines whether a previously derived continuity token has been re-detected following one or more interruption events, including device transitions, power loss or reboot, network interruptions, idle periods or lapse of user interaction, or removal and re-association of the continuity anchor device with the user.

Upon successful token recognition, the continuity restoration engine retrieves associated session state and re-establishes the contextual conversational environment without requiring network authentication, credential entry, or cloud retrieval of stored memory. In embodiments using the physically integrated secure processing enclave, continuity restoration is performed only upon receipt and verification of a cryptographic authorization artifact generated within the enclave, and is denied absent such artifact.

### 6.3 Conversational User-Interface Nodes

Conversational user-interface nodes may operate on any computing platform capable of exchanging user-interactive data with the continuity anchor device, including but not limited to wearable devices, vehicles and autonomous transport platforms, robotic systems, mobile terminals, fixed installations, entertainment systems, satellite communication terminals, head-mounted displays, neural interface endpoints, or cloud-hosted conversational or AI services. These nodes do not persist long-term personal identity data and rely solely on ephemeral continuity tokens or token references exchanged locally with the continuity anchor device to obtain continuity context.

### 6.4 Token Derivation and Encryption

The continuity token is generated using local cryptographic derivation mechanisms incorporating biometric or interaction signal preprocessing and normalization, statistical entropy quantization or feature extraction, rolling feature vector construction over sliding windows, and cryptographic hashing functions such as SHA-256 or similar primitives. Tokens are transient, revocable, and non-invertible. The continuity anchor device may rotate or refresh continuity tokens periodically or in response to security events. The encrypted memory store uses symmetric or asymmetric cryptographic encryption. In some embodiments, only truncated token indices and encrypted session payloads are stored.

### 6.4.1 Example Token Generation Algorithm

In one embodiment, the identity derivation engine samples pulse rate and motion data at predetermined sampling frequencies. Each feature is normalized, quantized into a fixed number of bits, concatenated into a feature string, combined with a device-specific secret value stored in a secure enclave, and processed through SHA-256 to produce a 128-bit continuity token. In informal prototype testing conducted entirely offline, the system consistently exceeded a same-user matching rate of zero point nine five across repeated sessions with low false acceptance.

### 6.4.2 Example Token Matching

A token comparison module computes a similarity metric between the new token and one or more previously stored reference tokens. In one embodiment, the similarity metric is a Hamming distance between token bit strings. If the similarity metric satisfies the continuity confidence threshold, the system authorizes retrieval of associated session context. If not, continuity restoration is denied.

### 6.4.3 Continuity State Machine Operation

In some embodiments, continuity management is performed using a multi-state execution model comprising Enrollment, Active Continuity, Matching, Authorization, Revocation, and Re-Enrollment states. This state-machine logic is executed locally on the continuity anchor device without reliance on centralized servers or cloud identity services.

### 6.5 Offline Operation

The continuity anchor device and user-interface nodes may function independently of persistent network connectivity. All continuity restoration operations can be executed locally or via direct device-to-device communication mechanisms without cloud dependency.

### 6.6 Additional Embodiments—Cognitive Continuity and Liveness Verification

### 6.6.1 Neural Echo/Passive Cognitive Continuity

In some embodiments, the continuity anchor device may passively detect non-semantic physiological or neural-adjacent signal patterns during periods of reduced interaction or sleep states, buffering them locally without semantic interpretation or remote transmission, and generating non-explicit continuity assistance outputs upon correlation with waking interaction patterns.

### 6.6.2 Liveness and Anti-Spoofing Verification

In some embodiments, the continuity anchor device applies liveness validation to ensure continuity authorization is based on genuine live-user biometric sampling rather than spoof replication. Liveness measures may include challenge-response testing of pulse-rate variability over randomized sampling windows, sensor fusion cross-validation between pulse, motion, thermal, and electro-dermal signals to detect physiological coherence, detection of temporal anomalies inconsistent with continuous biological signal generation, and detection of static or replayed signal patterns indicative of recording attacks. If spoofing or replay patterns are detected, continuity matching is denied, revocation protocols are initiated, and memory entries may be invalidated or erased.

### 6.7 Privacy and Data Control

No personally identifiable biometric data, raw neural recordings, or unprocessed sensor streams are stored permanently or transmitted externally. User memory may be selectively retained, erased, or purged. No cloud-based biometric identity storage or centralized session continuity servers are required.

### 6.8 Security and Tamper Protection

The continuity anchor device can include tamper detection circuits, encrypted secure enclaves, write-once memory fusing mechanisms, and hardware integrity checks configured to trigger cryptographic erasure of stored continuity keys, encrypted memory data, and associated continuity tokens upon detection of unauthorized access attempts or tampering. In docking-enabled embodiments, any external docking station is further configured to cryptographically erase temporary session keys and cached continuity data upon termination of the session.

### 6.9 Commercial and Software Integration

The system may operate with local transaction authorization mechanisms in which micro-transaction or local access triggers initiate temporary enhanced continuity features without dependency on centralized accounts, remote identity servers, or cloud-based validation. The continuity anchor device generates transaction authorization requests, verifies cryptographic receipts or zero-knowledge proofs, and updates a local time-locked authorization register. All operations are executed locally without network communication.

### 6.9.1 Micro-transaction Validation Protocol

In embodiments supporting micro-transactions, the transaction-based access control module executes a cryptographic validation protocol independent of cloud identity systems comprising: generation of a locally issued transaction request containing a timestamp, session continuity token hash reference, feature unlock identifier, and transaction request parameters; receipt of a cryptographic payment confirmation receipt; local validation using signature verification or zero-knowledge proof techniques; update of a local time-locked authorization register; and local execution of all operations without external transmission of continuity state or biometric data.

### 6.10 Clinical Disclaimer

The disclosed system does not provide medical diagnosis, mental health evaluation, dream interpretation, or neural therapeutic treatment.

### 6.11 Policy-Adaptive Continuity Operation

In certain embodiments, the biometric continuity token system applies one or more policy profiles governing continuity token processing, session state retention, and authorization verification. Policy profiles include a fully private local-operation mode, a regulated compliance mode, and a hybrid operation mode. In all cases, continuity token derivation, encrypted memory indexing, similarity-matching, and restoration logic remain locally executed on the continuity anchor device.

### 6.12 Protocol-Based Continuity Synchronization

In certain embodiments, the system implements a distributed continuity synchronization protocol defining structured message formats, cryptographic continuity tokens, handshake sequences, reconciliation rules, and state restoration ordering logic for transferring and synchronizing user or agent interaction context across heterogeneous computing platforms. The protocol operates independently of centralized identity directories.

### 6.13 Digital Persona and Autonomous Agent Continuity

In certain embodiments, continuity tokens may be derived from digital persona signatures, behavioral interaction profiles, or autonomous agent state fingerprints representing persistent conversational or operational identities of non-human or semi-autonomous entities. The encrypted memory indexing and continuity restoration engines process such persona-derived continuity tokens using the same similarity metrics and threshold confidence mechanisms.

### 6.14 Hardware-Neutral Anchor Implementations

In certain embodiments, the continuity anchor device may be implemented as a physical wearable apparatus, mobile terminal, implanted computing module, vehicle-integrated computing environment, robotic subsystem node, neural interface gateway, distributed trusted execution container, or fully virtualized cryptographic persona environment.

Such implementations encompass both dedicated hardware anchors and software-instantiated anchors operating within secure enclaves, trusted execution environments, containerized compute nodes, peer-to-peer mesh routers, or ledger-bound cryptographic entities. In all embodiments, the continuity token generation, encrypted memory indexing, similarity matching, authorization updating, and restoration logic remain functionally equivalent, independent of physical or virtual embodiment. In embodiments described in Sections 6.14.1 and 6.14.2 below, the continuity anchor device is a physical device with a physically integrated secure processing enclave and excludes software-only or remote instantiations for purposes of restoration authorization; those sections describe a stricter subclass of anchor implementations.

### 6.14.1 Secure Processing Enclave Physical Integration

In preferred embodiments, the secure processing enclave is physically disposed within the dedicated physical continuity anchor device and is explicitly not instantiable as, substitutable by, or satisfiable through any remote service, cloud-hosted execution environment, network-accessible trusted execution environment, or any enclave whose execution is initiated, managed, or terminable by a third-party operator or remote infrastructure provider. All continuity token derivation, repository decryption, authorization artifact generation, and liveness validation are performed exclusively within the physically integrated secure processing enclave using non-exportable hardware-bound key material.

The physical integration requirement means that the secure processing enclave shares a physical substrate—a single integrated circuit, system-on-chip, or dedicated security processor—with the biometric sensor array and tamper detection circuitry of the physical continuity anchor device. This co-location ensures that tamper events detected by the tamper detection circuitry can initiate immediate cryptographic erasure within the enclave without traversing any network interface, and that liveness signals acquired by the biometric sensor array are validated within the enclave without external transmission.

Remote attestation evidence—including remote TEE attestation certificates, cloud HSM proof-of-presence, or network-based cryptographic proofs of enclave integrity—by itself and absent satisfaction of on-device possession and liveness conditions, does not authorize continuity restoration under this architecture. Continuity restoration requires physical possession of the continuity anchor device, satisfaction of on-device liveness conditions evaluated within the physically integrated secure processing enclave, and generation of a cryptographic authorization artifact within the enclave using non-exportable hardware-bound key material that cannot be reproduced by any remote service.

In one embodiment, the secure processing enclave comprises a dedicated hardware security processor physically integrated into the physical continuity anchor device, executing all authorization operations in an isolated execution environment inaccessible to the device's general-purpose processor, operating system, and any software executing outside the enclave boundary, and inaccessible to any remote interface including debug interfaces, JTAG ports, external bus monitoring, and network-accessible management interfaces. The continuity restoration engine, which may execute outside the enclave boundary, is configured to restore session context data only upon receipt and verification of a cryptographic authorization artifact generated within the physically integrated secure processing enclave; the restoration engine is prohibited from restoring session context data absent such artifact, and no remote service, cloud-hosted execution environment, or network-accessible trusted execution environment can generate a conforming authorization artifact outside the physical continuity anchor device boundary without access to the non-exportable hardware-bound key material. In certain embodiments, the cryptographic authorization artifact includes a freshness binding comprising at least one of a nonce, monotonic counter, or time-window value, such that replay of a prior artifact is rejected. Remote attestation evidence and cloud-hosted signing services are insufficient to satisfy the authorization artifact requirement unless the artifact is generated within the physically integrated secure processing enclave using the non-exportable hardware-bound key material.

### 6.14.2 Federated Physical Anchor Recognition

In certain embodiments, two or more physical continuity anchor devices may establish federated recognition through encrypted trust messages that are validated and authenticated solely within each device's physically integrated secure processing enclave. This federated recognition architecture enables continuity handoff between physical anchor devices—for example, between a wearable anchor and a vehicle-integrated anchor—without requiring any centralized trust authority, cloud-hosted attestation service, or third-party operator involvement.

In federated recognition embodiments, each physical continuity anchor device generates a federating continuity reference comprising a cryptographic derivative of its locally derived continuity token and an enclave-signed device assertion generated within and signed by the physically integrated secure processing enclave without dependence on any remote attestation service. The receiving physical continuity anchor device validates the federating continuity reference exclusively within its own physically integrated secure processing enclave, without network connectivity and without reliance on any shared remote infrastructure. Validation success authorizes a time-limited, scope-limited continuity sharing session between the two physical anchor devices.

Remote attestation services, cloud-hosted key management services, and network-accessible trust registries, by themselves and absent physical possession conditions, do not establish or validate federated recognition under this architecture. Federated recognition requires that both participating devices possess physically integrated secure processing enclaves with non-exportable hardware-bound key material and that validation is performed exclusively within those enclaves.

### ALTERNATIVE EMBODIMENTS

The present disclosure may be implemented across a wide range of hardware substrates including wearable pendants, bracelets, rings, head-mounted devices, implanted computing modules, hybrid biometric authentication accessories, vehicle-mounted biometric terminals, robotic interface relays, satellite uplink identity modules, and secure hardware modules. Communication methods may include wired ports, wireless RF links, Bluetooth Low Energy communications, satellite uplinks, optical transceivers, or bio-electrical couplings. Cryptographic derivation algorithms may include hashing, rolling entropy derivation, zero-knowledge proof tokenization, homomorphic encryption-assisted comparisons, or secure enclave-processed biometric transformations.

### CONCLUSION

The present disclosure enables secure and privacy-preserving continuity of interactive computing sessions across distributed devices without dependence on centralized cloud identity infrastructures or storage of personal biometric identifiers, and further provides a physically integrated, sovereignty-preserving secure processing enclave architecture in which remote services and cloud-hosted execution environments cannot substitute for the physical continuity anchor device.

1. A hardware-bound continuity anchoring system for sovereign session restoration across heterogeneous user-interface nodes, comprising:
a) a physical continuity anchor device comprising one or more biometric or interaction-derived signal sensors and a secure processing enclave physically integrated within the physical continuity anchor device, wherein the secure processing enclave is not instantiable as, substitutable by, or satisfiable through any remote service, cloud-hosted execution environment, or network-accessible trusted execution environment;
b) non-exportable hardware-bound key material stored within the physically integrated secure processing enclave in a manner that prevents extraction, transmission, or derivation of the key material outside the enclave boundary through any software, firmware, hardware, or remote interface;
c) one or more processors of the physically integrated secure processing enclave configured to derive a non-invertible continuity token from one or more biometric or interaction-derived signals combined with a device-specific secret stored within the physically integrated secure processing enclave, using a cryptographic derivation function executed at least in part within the physically integrated secure processing enclave;
d) an encrypted continuity state repository indexed to the continuity token, encrypted at rest and stored locally within a non-transitory storage medium of the physical continuity anchor device, wherein repository decryption keys are retained exclusively within the physically integrated secure processing enclave and are not transmitted to any heterogeneous user-interface node or remote service;
e) tamper detection circuitry physically co-located with the physically integrated secure processing enclave and configured to initiate cryptographic erasure of stored continuity tokens and repository decryption keys upon detection of unauthorized access, without requiring any network communication or remote authorization;
f) one or more processors of the physically integrated secure processing enclave configured to validate a similarity metric between a re-derived continuity token and one or more stored reference continuity tokens against a predefined continuity confidence threshold, the validation being performed exclusively within the physically integrated secure processing enclave; and
g) a continuity restoration engine configured to restore session context data upon re-detection of a continuity token for which a similarity metric satisfies a predefined continuity confidence threshold and only upon receipt and verification of the cryptographic authorization artifact generated within the physically integrated secure processing enclave, the continuity restoration engine being prohibited from restoring session context data absent said cryptographic authorization artifact,
wherein remote attestation evidence is insufficient, by itself, to authorize continuity restoration absent (i) physical possession of the physical continuity anchor device and (ii) satisfaction of on-device liveness conditions evaluated within the physically integrated secure processing enclave, and wherein continuity restoration requires generation within the physically integrated secure processing enclave of a cryptographic authorization artifact bound to the continuity token and liveness result, using the non-exportable hardware-bound key material, and wherein any remote authentication, cloud-based authorization, remote attestation, federated identity assertion, or external cryptographic validation is insufficient to authorize continuity restoration in the absence of generation of the cryptographic authorization artifact within the physically integrated secure processing enclave.

2. The system of claim 1, wherein the physically integrated secure processing enclave comprises a dedicated hardware security processor physically integrated into the physical continuity anchor device and executing all authorization operations in an isolated execution environment inaccessible to the device's general-purpose processor, operating system, and any software or interface executing outside the enclave boundary.

3. The system of claim 1, wherein the one or more biometric or interaction-derived signal sensors are physically co-located on the physical continuity anchor device with the physically integrated secure processing enclave such that liveness signals acquired by the sensors are validated within the enclave without transmission to any external system.

4. The system of claim 1, wherein the tamper detection circuitry is physically co-located with the physically integrated secure processing enclave such that a tamper event initiates immediate cryptographic erasure within the enclave without traversing any network interface or requiring remote authorization.

5. The system of claim 1, wherein detection of a tamper event by the tamper detection circuitry further triggers cryptographic erasure of encrypted continuity state data stored in the encrypted continuity state repository, rendering all stored session context irrecoverable.

6. The system of claim 1, wherein the non-exportable hardware-bound key material cannot be mirrored, escrowed, re-hosted, or made accessible outside the physically integrated secure processing enclave by any third-party operator, remote service, cloud-hosted key management service, or network-accessible management interface.

7. The system of claim 1, wherein the physically integrated secure processing enclave performs possession-bound liveness validation by sensor-fusion cross-validation between at least two biometric or interaction-derived signals physically acquired by sensors of the physical continuity anchor device, and wherein remote attestation evidence, cloud-hosted biometric verification, and network-based liveness proofs are insufficient to satisfy the liveness validation requirement.

8. The system of claim 1, wherein the predefined continuity confidence threshold comprises a maximum Hamming distance acceptance value evaluated between bit strings of the re-derived continuity token and a stored reference continuity token derived by applying a SHA-256 cryptographic hashing function to a concatenation of a quantized biometric or interaction feature vector and the device-specific secret.

9. The system of claim 1, further comprising a docking interface configured to authenticate pairing using a hardware-bound cryptographic credential of the physical continuity anchor device, enable a time-limited controlled data access mode, and cryptographically erase temporary session keys, cached continuity data, and authentication credentials upon termination such that no cached continuity state or temporary biometric-derived data remains accessible outside the physical continuity anchor device after termination.

10. The system of claim 1, wherein two or more physical continuity anchor devices establish federated recognition through encrypted trust messages validated and authenticated solely within each device's physically integrated secure processing enclave, without requiring any centralized trust authority, cloud-hosted attestation service, or network connectivity.

11. The system of claim 1, further comprising a safety governance layer configured to monitor biometric indicators to detect distress, prolonged absence, or tamper conditions, and to initiate cryptographic erasure of continuity state data and invalidation of continuity tokens upon detection of a predefined safety event, wherein the safety governance layer executes within or under control of the physically integrated secure processing enclave.

12. The system of claim 1, wherein the physical continuity anchor device operates under dynamically selectable policy profiles comprising at least a private local-operation mode, a regulated compliance mode, and a hybrid operation mode, wherein continuity token derivation, similarity matching, and restoration logic remain locally executed within the physically integrated secure processing enclave regardless of the selected policy profile.

13. The system of claim 1, wherein the physical continuity anchor device comprises at least one of a wearable pendant, bracelet, ring, or head-mounted unit, a mobile terminal, a vehicle-integrated computing module, a robotic interface node, or a neural interface gateway.

14. The system of claim 1, wherein the continuity token is further derivable from at least one of digital persona signatures, behavioral interaction profiles, or autonomous agent state fingerprints, enabling session continuity for both human users and non-human digital identity entities.

15. The system of claim 1, wherein the physically integrated secure processing enclave rotates or refreshes continuity tokens periodically or responsive to a tamper event or a spoofing or replay pattern detection event, deriving rotated continuity tokens from newly acquired biometric or interaction-derived signals combined with the device-specific secret exclusively within the enclave.

16. The system of claim 1, wherein each heterogeneous user-interface node receiving session context data from the physical continuity anchor device receives only encrypted continuity state fragments sufficient to resume interaction at a point of interruption, the repository decryption keys remaining stored within the physically integrated secure processing enclave and not transmitted to any heterogeneous user-interface node.

17. The system of claim 1, wherein remote attestation evidence, cloud-hosted key management services, and network-based cryptographic proofs of enclave integrity, by themselves and absent on-device possession and liveness conditions, do not authorize continuity restoration; continuity restoration further requires physical possession of the physical continuity anchor device as evaluated by on-device sensor-fusion liveness validation performed within the physically integrated secure processing enclave.

18. The system of claim 1, wherein continuous network connectivity is not required as a prerequisite to continuity restoration and wherein all continuity token derivation, similarity evaluation, liveness validation, and restoration authorization operations are executable without network access.

19. The system of claim 1, wherein the physically integrated secure processing enclave is implemented as a dedicated security processor having a hardware-enforced isolated execution environment and protected memory inaccessible to non-enclave software, including the device operating system, hypervisor, and firmware update mechanisms executing outside the enclave boundary.

20. A computer-implemented method executed by a physical continuity anchor device comprising a physically integrated secure processing enclave that is not instantiable as, substitutable by, or satisfiable through any remote service, cloud-hosted execution environment, or network-accessible trusted execution environment, the method comprising:
a) acquiring biometric or interaction-derived signals from one or more sensors physically co-located on the physical continuity anchor device;
b) deriving a non-invertible continuity token from the acquired signals combined with a device-specific secret stored within the physically integrated secure processing enclave, using a cryptographic derivation function executed at least in part within the physically integrated secure processing enclave;
c) indexing encrypted continuity state data to the continuity token in an encrypted continuity state repository under exclusive cryptographic control of the physically integrated secure processing enclave;
d) performing possession-bound liveness validation within the physically integrated secure processing enclave by sensor-fusion cross-validation between at least two biometric or interaction-derived signals physically acquired by sensors of the physical continuity anchor device;
e) evaluating a similarity metric between a re-derived continuity token and one or more stored reference continuity tokens against a predefined continuity confidence threshold exclusively within the physically integrated secure processing enclave; and
f) restoring session continuity upon re-detection of a continuity token for which a similarity metric satisfies a predefined continuity confidence threshold and upon satisfaction of the possession-bound liveness validation, without requiring remote attestation, cloud-hosted verification, or network-based authorization, and wherein any remote authentication, cloud-based authorization, remote attestation, federated identity assertion, or external cryptographic validation is insufficient to authorize continuity restoration in the absence of generation of the cryptographic authorization artifact within the physically integrated secure processing enclave,
wherein remote attestation evidence, by itself and absent satisfaction of on-device possession and liveness conditions, does not authorize continuity restoration or access to repository decryption keys.

21. The method of claim 20, further comprising detecting a tamper event using tamper detection circuitry physically co-located with the physically integrated secure processing enclave and initiating cryptographic erasure of stored continuity tokens and repository decryption keys immediately upon detection without network communication.

22. The method of claim 20, further comprising rotating or refreshing continuity tokens responsive to a tamper event or spoofing or replay pattern detection event, deriving rotated identifiers exclusively within the physically integrated secure processing enclave.

23. The method of claim 20, further comprising establishing federated recognition with a second physical continuity anchor device by exchanging encrypted trust messages validated solely within each device's physically integrated secure processing enclave, without network connectivity or centralized trust authority.

24. The method of claim 20, further comprising, upon termination of a controlled data access session via a docking interface, cryptographically erasing temporary session keys and cached continuity data such that no cached continuity state remains accessible outside the physical continuity anchor device after termination.

25. The method of claim 20, further comprising monitoring biometric indicators using a safety governance layer executing within or under control of the physically integrated secure processing enclave, and initiating cryptographic erasure of continuity state data upon detection of a predefined safety event.

26. A non-transitory computer-readable medium storing machine-executable instructions that, when executed by one or more processors of a physical continuity anchor device comprising a physically integrated secure processing enclave that is not instantiable as, substitutable by, or satisfiable through any remote service, cloud-hosted execution environment, or network-accessible trusted execution environment, cause the physical continuity anchor device to:
a) derive a non-invertible continuity token from one or more biometric or interaction-derived signals combined with a device-specific secret stored within the physically integrated secure processing enclave, using a cryptographic derivation function executed at least in part within the physically integrated secure processing enclave, such that the device-specific secret is retained as non-exportable hardware-bound key material within the enclave;
b) index encrypted continuity state data to the continuity token in an encrypted continuity state repository, repository decryption keys for which are retained exclusively within the physically integrated secure processing enclave and not transmitted to any heterogeneous user-interface node or remote service;
c) perform possession-bound liveness validation by sensor-fusion cross-validation between at least two biometric or interaction-derived signals physically acquired by sensors of the physical continuity anchor device, within the physically integrated secure processing enclave;
d) evaluate a similarity metric between a re-derived continuity token and one or more stored reference continuity tokens against a predefined continuity confidence threshold, exclusively within the physically integrated secure processing enclave;
e) restore session context data upon re-detection of a continuity token for which a similarity metric satisfies a predefined continuity confidence threshold and upon satisfaction of the possession-bound liveness validation, without requiring remote attestation or cloud-hosted verification, and wherein any remote authentication, cloud-based authorization, remote attestation, federated identity assertion, or external cryptographic validation is insufficient to authorize continuity restoration in the absence of generation of the cryptographic authorization artifact within the physically integrated secure processing enclave; and
f) upon detection of a tamper event by tamper detection circuitry physically co-located with the physically integrated secure processing enclave, initiate cryptographic erasure of stored continuity tokens and repository decryption keys without network communication, wherein remote attestation evidence, by itself and absent satisfaction of on-device possession and liveness conditions, does not authorize continuity restoration or access to repository decryption keys.

27. The non-transitory computer-readable medium of claim 26, wherein the instructions further cause the physical continuity anchor device to establish federated recognition with a second physical continuity anchor device by exchanging encrypted trust messages validated solely within each device's physically integrated secure processing enclave without centralized trust authority or network connectivity.

28. The non-transitory computer-readable medium of claim 26, wherein the instructions further cause the physical continuity anchor device to derive continuity tokens additionally from at least one of digital persona signatures, behavioral interaction profiles, or autonomous agent state fingerprints, enabling session continuity for both human users and digital agents.

29. The system of claim 1, wherein continuity restoration authorization cannot be completed by any remote trusted execution environment or cloud-hosted service lacking physical access to the non-exportable hardware-bound key material stored within the physically integrated secure processing enclave.

30. The system of claim 1, wherein the continuity restoration engine is prohibited from restoring session context data in the absence of both (i) a similarity metric satisfying the predefined continuity confidence threshold and (ii) the cryptographic authorization artifact generated within the physically integrated secure processing enclave, such that satisfaction of the similarity metric alone is insufficient to authorize restoration.
